(19) United States
(12) Patent Application Publication
(10) Pub. No.: US 2014/0195968 A1
(43) Pub. Date: Jul. 10, 2014

(54) INFERRING AND ACTING ON USER INTENT

(71) Applicant: HEWLETT- PACKARD DEVELOPMENT COMPANY, L.P., Houston, TX (US)

(72) Inventor: Madhusudan Banavara, Bangalore (IN)

(73) Assignee: HEWLETT-PACKARD DEVELOPMENT COMPANY, L.P., Houston, TX (US)

(21) Appl. No.: 13/737,622

(22) Filed: Jan. 9, 2013

(51) Int. Cl. G06F 3/0482

(52) U.S. Cl. CPC G06F 3/0482
USPC 715/810

(57) ABSTRACT

A method for inferring and acting on user intent includes receiving, by a computing device, a first input and a second input. The first input includes data associated with a first real world object and the second input includes selection by a user of an image representing a second real world object. A plurality of potential actions that relate to at least one of the first input and the second input are identified. The method further includes determining, from a plurality of potential actions, an action that is inferred by a relationship between the first real world object and the second real world object. The action inferred from the relationship between the first real world object and the second real world object is performed. A computing device for inferring and acting on user intent is also provided.

### BACKGROUND

Performing relatively straightforward tasks using electronic devices can require a significant number of user steps and attention. This creates significant time and energy barriers to performing specific actions. In some instances, these barriers can be higher for mobile devices because mobile devices are used in new locations and situations that may require more discovery and configuration. For example, a business traveler may receive and view an electronic document on their mobile device. To print the document, the user has to perform a number of steps, including physically finding a printer, discovering which network the printer is connected with, identifying which network name the printer is using, connecting to that network, authenticating the user on that network, installing printer drivers, determining the settings/capabilities of the printer, formatting the document for printing on the printer, and, finally, sending the document over the network to the printer. The steps in for printing a document can be a significant barrier for the user to overcome. Consequently, the user may not print the document because the required effort, time, and uncertainty of a successful result.

### BRIEF DESCRIPTION OF THE DRAWINGS

The accompanying drawings illustrate various examples of the principles described herein and are a part of the specification. The illustrated examples are merely examples and do not limit the scope of the claims.

FIG. 1 is a flowchart and accompanying drawings of a method and system for inferring and acting on user intent, according to one example of principles described herein.

FIGS. 2A, 2B, and 2C are screen shots of one example of mobile phone application that infers and acts on user intent, according to one example of principles described herein.

FIG. 3 is a diagram showing a distributed network of computing devices that infer user intent and take appropriate action based on that intent, according to one example of principles described herein.

FIG. 4 shows multiple elements that are displayed in a single image to infer and act on user intent, according to one example of principles described herein.

FIG. 5 is a diagram showing a system for inferring and acting on user intent, according to one example of principles described herein.

FIG. 6 is a flowchart of a method for inferring and acting on user intent using a computing device, according to one example of principles described herein.

Throughout the drawings, identical reference numbers designate similar, but not necessarily identical, elements.

### DETAILED DESCRIPTION

Minimizing the procedural barriers to executing actions with computing devices can significantly improve the user experience. When the barriers are minimized, the user will be more likely to perform the actions. The principles described below relate to methods and systems for inferring user intent and then automatically performing actions based on the inferred user intent. These actions include taking procedural steps to accomplish the user intent. This allows the user to intuitively direct the computing device(s) to perform an action without having to manually direct the computing device to take each of the required steps. In some situations, the user may not even know the steps that the computer takes to perform the action. The user provides intuitive input to the computer and the computer takes the steps to produce the desired result.

In one implementation, a first input is received by the computing device. The first input may be any of a number of events. For example, the first input may be receipt or usage of data, audio inputs, visual inputs, or other stimulus from the user's environment. The user provides a second input and the computing device(s) derives a relationship between the first input and the second input. In some cases, the second input is an action taken by the user in response to the first input. The user's awareness and reaction to the first input and circumstances surrounding the first input lead to the second input by the user. These and other relationships between the first input and second input allow the computing device to infer an action that is intended by the user. The computing device then takes the action.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an example” or similar language means that a particular feature, structure, or characteristic described in connection with the example is included in at least that one example, but not necessarily in other examples.

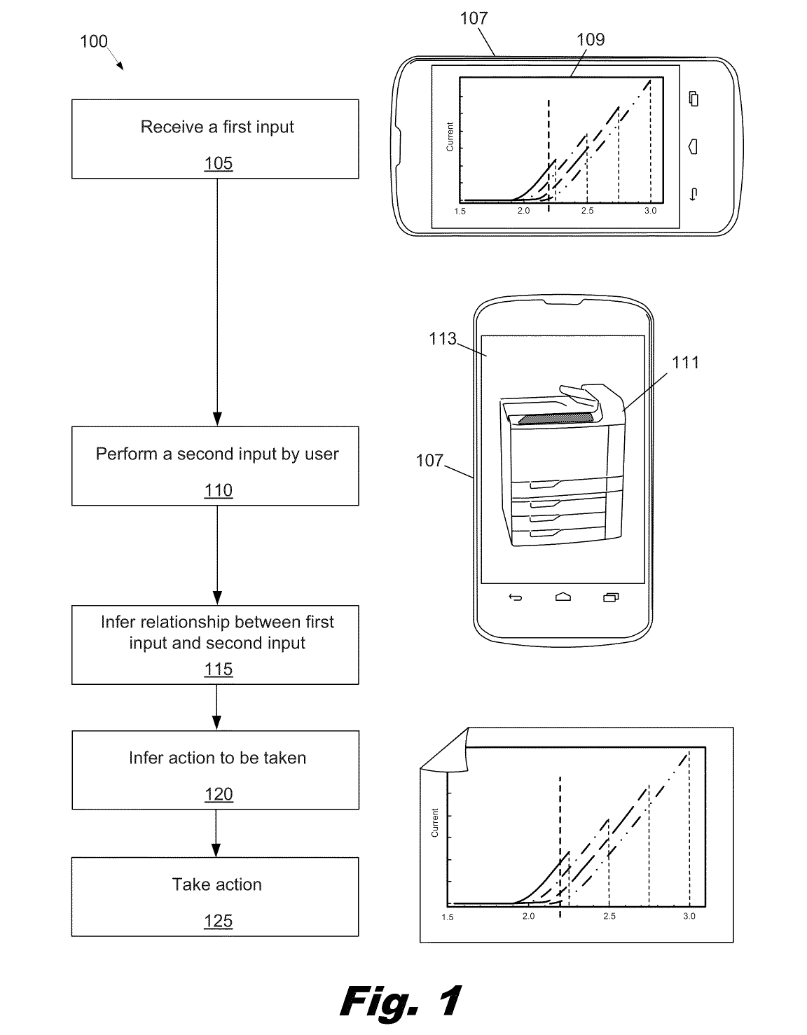

FIG. 1 shows a flowchart (100) and diagrams associated with several of the blocks in the flowchart. A first input is received by the computing device (block 105). The first input may take a variety of forms, including taking a picture, voice input, text, touch input, finger/hand motion, opening a specific website, detection of a physical location, acceleration, temperature, time, sensor data or other inputs. The first input may be initiated by a user of the computing device, remote or local sensors, remote users, receipt of data over a network, or other entity or event.

In the example shown in FIG. 1, the first input is the display of an image of a graph (109) by a mobile computing device (107). The graph may be directly generated by the user or may be received by the computing device from an external source. The first input or action may include viewing of the image of the graph or other document by the user on the mobile device.

A second input or action is performed by the user (block 110). In this example, the second input is the user identifying a picture (113) with the mobile device (107) of a printer (111) that is in proximity to the user. The user may directly take the picture of the printer with the mobile device (107), retrieve the picture from a database or may extract an image of the printer from a video stream produced by the mobile device (107).

The computing device (107) then infers a relationship between the first input and second input (block 115). In this example, the computing device determines that the relationship exists between the image of the graph (109) that the user previously viewed and the current image (113) of the printer (111). This relationship may be that the graph (109) can be printed by the printer (111). The computing device making this determination may be the mobile device or a different computing device that is in communication with the mobile device.

The computing device then infers an action to be taken (block 120). In the example above, the computing device determines that the graph should be printed on the printer. The computing device may confirm this action with the user or may automatically proceed with the action. For example, if the user has repeatedly performed printing operations similar to the desired printing operation in the past, the computing device may not ask for confirmation by the user. However, if this is a new action for the user, the computing device may ask the user to confirm the action.

The computing device then automatically takes the action (block 125). In this example, computing device may perform the following steps to complete the action. First, the computing device identifies the printer (111) in the image. The computing device may identify the printer in any of a variety of ways. For example, the computing device may access a network and determine which printers are connected and available to for printing. Using the name, location, and attributes of the printers that are connected to the network, the computing device determines which of the printers the user has selected a picture of. Additionally or alternatively, the printer may have unique characteristics that allow it to be identified. For example, the printer may have a barcode that is clearly visible on the outside of the printer. The barcode could be a sticker affixed to the body of the printer or may be displayed on a screen of the printer. By taking an image of the barcode with the mobile device the printer is uniquely identified. Additionally the barcode could identify the characteristics of the printer such as the printer's network address or network name, the printer capabilities (color, duplex, etc.) and other printer characteristics. If the physical location of the printer is known, the computing device may derive which printer is shown in the image using the GPS coordinates where the picture of the printer was taken by the user.

The computing device creates a connection with the printer. The computing device may make a direct connection to the printer. Alternatively, the printer may connect to the printer using a network. This may require authenticating and logging the mobile device into the network. The computing device may also install any software or drivers that are required and sets up the printer to print the graph (e.g. selects an appropriate paper size, duplex/single settings, color/black and white, and other settings). The computing device then formats the graph data and sends it to the printer for printing.

Because the computing device is configured to infer the user's intention and automatically act on it, the user's experience is significantly simplified. From the user's perspective, the user simply views the graph or other material and takes a picture of the printer the material should be printed on. The material is then printed as the user waits by the printer.

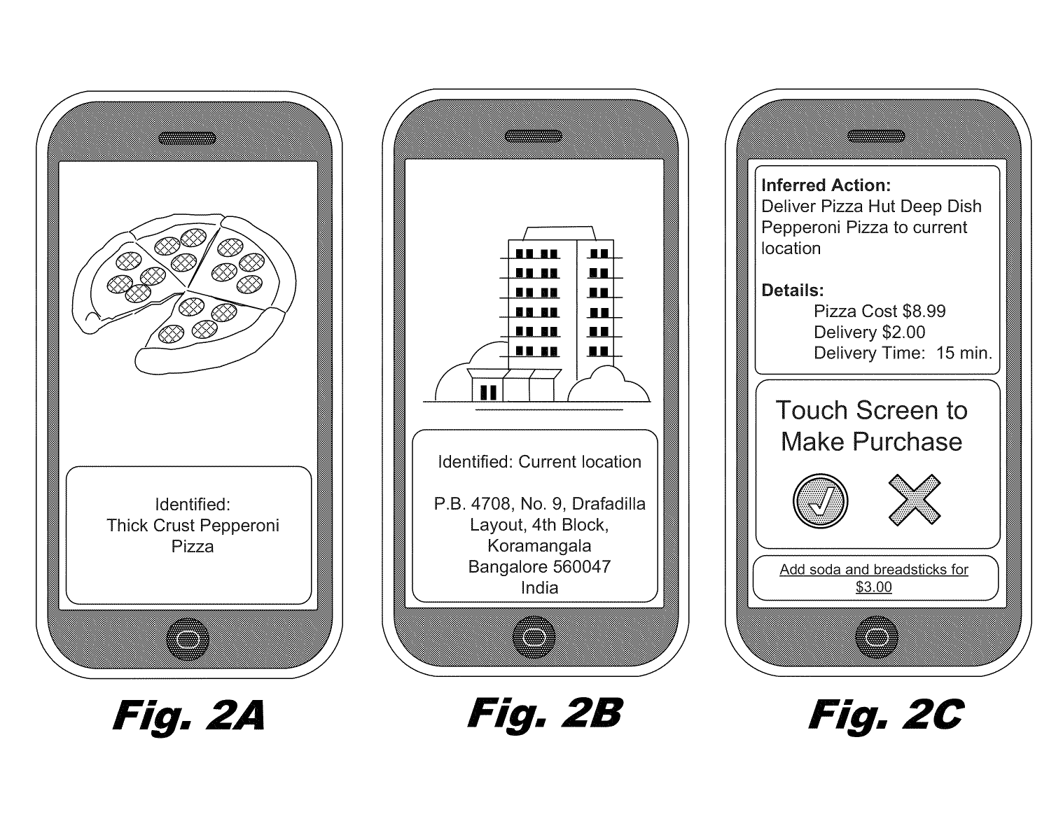

The example given above is only one illustration. The principles of inferring user intent from a series of inputs/action can be applied to a variety of situations. FIGS. 2A-2C show a series of screenshots of a computing device inferring and acting on user intent. The computing device may be any of a number of devices. For example, the computing device may be a mobile phone, a tablet, laptop, handheld gaming system, music player, wearable computer, or other device. In some implementations, the principles may be implemented by networked computing devices. For example, a mobile device may be used to gather information and interact with the user while a significant amount of the computation and databases may be hosted on a remote computer(s).

In FIG. 2A, the user has input a picture of a pizza using the mobile device. The picture may be directly taken from a physical pizza, an advertisement, billboard, or may be taken from the internet or other database. The computing device identifies this input. In this example, the computing device determines that image is of a thick crust pepperoni pizza. In general, the input may be any data that is associated with a first real world object and may be in the form of a picture, video, text, sensor data, wireless signal or other input. The input may be received by an input component of the mobile device. The input component may be a wireless receiver, a touch screen, a camera, a keypad, or other component capable of receiving data or generating data from user inputs.

FIG. 2B shows a screen shot of the second input. The second input is a selection or input by a user of an image representing a second real world object. In general, the computing device identifies a plurality of potential actions that relate to at least one of the first input and second input and determines from the plurality of potential actions, an action that is inferred by a relationship between the first real world object and the second real world object.

In this example, the second input is a picture of the exterior of the user's apartment building. The computing device has identified the apartment building location and address. This may be performed in a variety of ways, including image recognition, GPS information from the mobile device, or if the image is selected from a database, by using metadata associated with the image.

The computing device makes the association between the first input and second input and determines which action is inferred. The computing device will then take the action inferred by the relationship between the first real world object and the second real world object. This action may be a prompt or display of information to the user and/or actions taken by the computer to generate a change in real world objects.

FIG. 2C shows the computing device communicating the inferred action, details of the action and a request for the user to confirm that they want the action to move forward. The communication component of the system may include data, visual, audio, tactile or other communication with the user or other computing device. In this example, the inferred action is to have pizza delivered to the user's apartment. The computing device may have performed a variety of actions to generate the displayed information. For example, the computing device may have accessed a website listing the local restaurants with food delivery service, checked a history of purchases made by the user to determine their preferences, checked prices and delivery times for pizza at one or more restaurants, compared pricing, retrieved coupons, and other actions. The “details” section lists the costs for the pizza/delivery and the estimated time for the delivery. A display requests that the user touch the screen to make or decline the purchase of the pizza. Other options for the action may also be displayed. In this example, the user is given the option to add additional items to their order. Other options may include ordering pizza from a different source, placing an automatically dialed phone call to the pizza restaurant so that the user can directly communicate with the proprietors, or viewing a menu from the restaurant. The user can confirm the action, along with any options, and the computing device will make the order.

In some examples, the computing device may continue to monitor the progress of the action. For example, the computing device may access data from the restaurant regarding the status of the order, notify a doorman of the pizza delivery, etc.

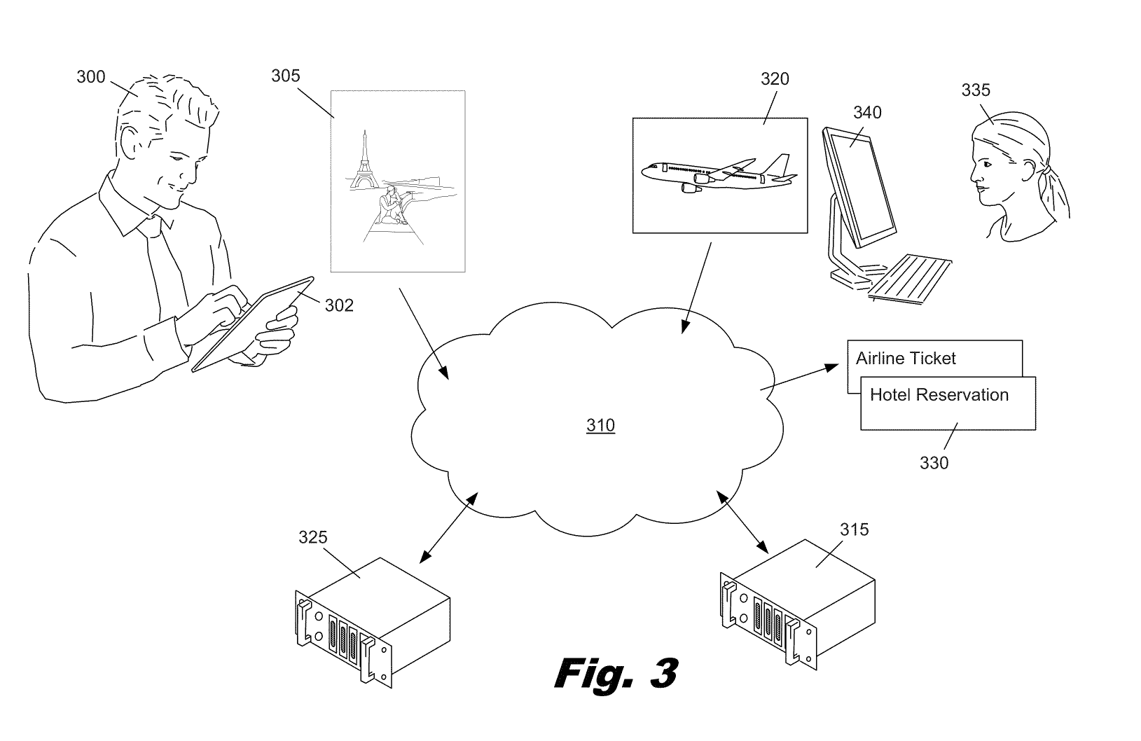

FIG. 3 is a diagram showing a distributed network of computing devices that infer user intent and take appropriate action based on that intent. In this example, a man (300) is traveling on business in Paris and takes an image (305) of a prominent landmark in Paris with his mobile device. The man sends the image (305) and perhaps a quick note (“Please join me in Paris!”) to a woman (335) at a different location. The image (305) is sent to the woman's computing device (340) via a network (310). The network (310) may include a variety of different technologies such as cellular networks, Ethernet, fiber optics, satellite networks, wireless networks, and other technologies. For example, the man's mobile device (302) may be directly connected to a cellular network, which receives the data and passes it to the internet infrastructure that communicates it to the woman's computing device (340).

In response to the receipt of the image/text (305) from the man (300), the woman (335) takes an action to retrieve or view an image of a passenger jet (320). In this example, the man's action and the woman's action are monitored by an external user intent application server (325). The application server (325) derives the intent of the woman (335) to travel to Paris and takes appropriate steps to secure an airline ticket to Paris and hotel reservation (330) in Paris for the woman (335). The application server (325) may take steps such as identifying the location of the woman, accessing the calendars of the man and woman to identify the appropriate travel times, contacting a travel services server (315) to identify the best airline/hotels for the time and locations. The application server (325) may request authorization from the woman and/or man to proceed at various points in the process.

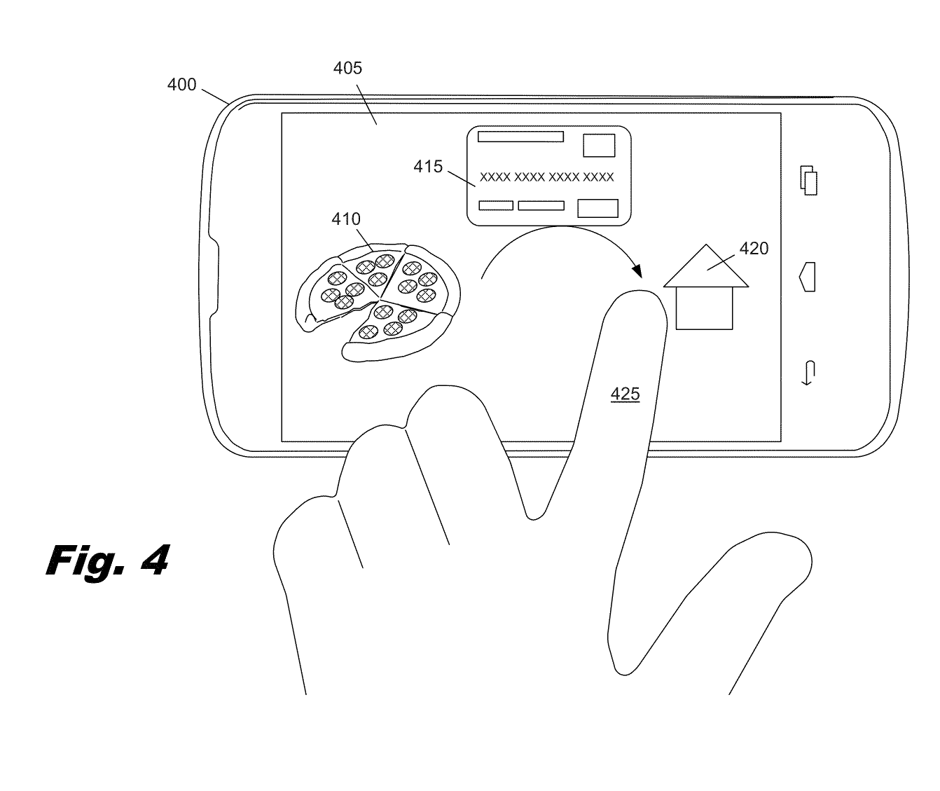

FIG. 4 shows multiple elements (410, 415, 420) that are displayed in a single image (405). In this example, the image (405) contains images of a pizza (410), a credit card (415) and an icon of a house (420). To order and pay for the pizza to be delivered to the user's house, the user simply swipes their finger (425) across the image (405). The path of the finger swipe across the image is shown by the curved arrow. In this example, the user's finger swipe first identifies the pizza (a first input), then identifies the payment method (second input) and then identifies the location the pizza should be delivered to (third input). Following these inputs from the user, the mobile computing device interfaces with computing device associated with the pizza restaurant to negotiate the desired transaction and delivery.

The user can modify the images displayed by the mobile device in a variety of ways. For example, the user may touch the pizza and swipe their finger to the left to remove the pizza from the image. The pizza could then be replaced by a different purchase option. Similarly, the user could change methods of payment or delivery options.

The computing device may use a variety of techniques to derive the relationship between the inputs. For example, the computing device may track the path, speed and direction of the user's finger. The path of the user's finger may indicate a temporal sequence that the user intends the real world actions to follow. In FIG. 4, the computer could infer that the user intends to pay for the pizza prior to its deliver to the user's house. However, if the path of the finger swipe traveled from the pizza to the house and then to the credit card, the computing device could determine that the user intends for the pizza to be delivered to the house and then payment will be made.

The examples given above are illustrative of the principles described. A variety of other configurations could be used to implement the principles. For example, the inferred action functionality may be turned on and off by the user. Other controls may include enabling automatic actions that do not require user confirmation or other options. In other embodiments, videos or images of the user may be used as inputs. This may be particularly useful for hearing impaired individuals that use sign language to communicate.

As shown above, one simple example of inferring and acting on user intent is when a prior action of the user, such as browsing a document on a mobile device, is followed by a second action by the user, such as identifying a printer. A computing device can then infer a relationship between the two user actions and perform a default action on the object, such as printing the document.

In other examples, the user may make a single gesture across a display of multiple objects. An action may then be taken by inferring the user's intent based on the inferred relationship between those objects. In some examples, the relationships/actions may be preconfigured, user defined, crowd/cloud sourced or learned. For example, the learning process may involve observing user action patterns and the context surrounding those user actions. Additionally or alternatively, the learning process may include prompting the user to verify inferences/actions and storing the outputs for later recall. Other examples include associating actions for every object and picking the action that is most relevant. In some examples, output of a first inference or action operation can be an input for the next inference or operation. The inputs could include sounds, voice, light temperature, touch input, text, eye motion, or availability of WiFi/Cell network, time of day, festival or event associated with the day.

In one example, a voice input (by the user or someone else) includes the words “National Geographic.” The user then indicates a television by selecting an image of a television, pointing nearby the television or taking a picture of the television. The computing device then infers that the user wants an action to be taken by the TV and determines that words “National Geographic” are relevant to an available channel. The computing device then tunes the television to the National Geographic Channel.

In another example, the computing device may sense other environmental inputs such as ambient light levels, a clinking of wine glasses, or a voice prompt that says “romantic.” The computing device could then tune the TV to a channel that is broadcasting a romantic movie. If the ambient light level sensed by the computing device is high (first input) and the indicated object is a lamp/chandelier (second input), the computing device could infer that the lamp/chandelier should be turned off. Similarly, if the ambient light level is low and the indicated object is a lamp/chandelier, the computing device could infer that the lamp/chandelier should be turned on.

As discussed above, the computing device may sense a variety of other environmental variables. If the computing device senses that the ambient temperature is high (a first input) and the object identified is an air conditioner (second input), the computing device may take the action of turning on the air conditioner. Similarly, if the ambient temperature is low, and the object identified is a heater, the computing device may turn on the heater.

The mobile computing device may also sense the vital signs of the person holding or carrying the computing device. For example, the mobile computing device may sense blood sugar levels, heart rate, body temperature, voice tone, or other characteristics using a variety of sensors. If the vitals indicate distress (first input) and an ambulance is indicated (second input), the mobile computing device may dial 911 and report the user's location and vital signs. If the vitals signs indicate the user's condition is normal and healthy (first input) and the user selects an ambulance (second input), the computing device may put a call through to the user's doctor so that the user can ask for specific advice.

If a WiFi network is determined to be available (a first input) and the selected object is a music system (second input), the computing device may infer that the user desires to stream music to the music system over the WiFi network. The computing device may then take appropriate actions, such as connecting to the WiFi network, locating the music system as a device on the network, opening an internal or external music application, and streaming the music to the music system.

In one example, the computing device may determine that it is the first Sunday in November (first input) and the user may select a clock (second input). The computing device determines that first Sunday in November is when daylight savings changes the time back an hour. This computing device then determines that user's desired action is to correct the time on the clock.

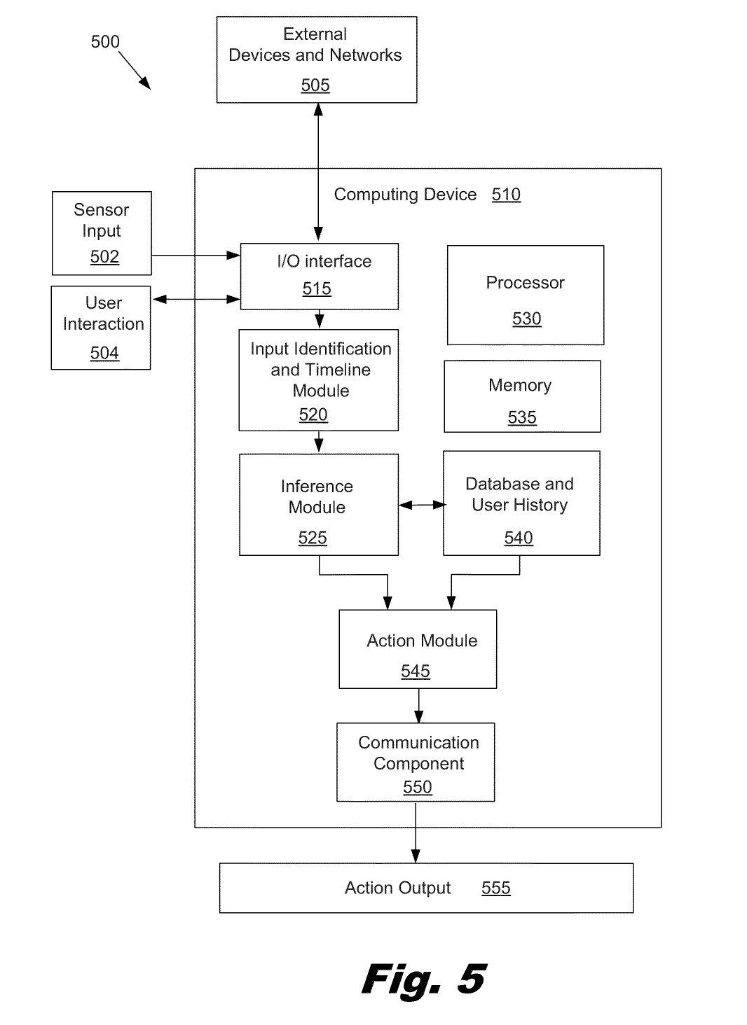

FIG. 5 is a diagram of one example of a system (500) for inferring and acting on user intent. The system (500) includes at least one computing device (510) with a processor (530) and a memory (535). The processor retrieves instructions from the memory and executes those instructions to control and/or implement the various functionalities and modules of the computing device (510). The computing device also includes an input component which is illustrated as an I/O interface (515), an input identification and timeline module (520), an inference module (525), an action module (545) and a user history (540). The I/O interface (515) may interact with a variety of elements, including external devices and networks (505), receive sensor input (502) and interact with the user (504). The I/O interface (515) accepts these inputs and interactions and passes them to the input identification and timeline module (520). This module identifies the inputs, their significance and places the inputs on a timeline. The input identification and timeline module (520) may make extensive use of the outside resources accessed through I/O interface to interpret the significance of inputs.

An inference module (525) accesses the time line of inputs and infers relationships between the inputs. The inference module (535) may use a variety of resources, including a database and user history (540). The database and user history may include a variety of information, including input sequences/relationships that led to user approved actions. The inference module (525) may use external databases, computational power, and other resources to accurately make a determination of which action should be taken based on the relationship between the inputs. In some situations, the exact action to be taken may not be confidently determined. In this case, the inference module may present the user with various action options for selection or ask for other clarifying input by the user.

The action module (545) then takes the appropriate sequence of steps to execute the desired action. The action module (545) may use the database and user history to determine how to successfully execute the action if the action has been previously performed. The action module may also interact with the user to receive confirmation of various steps in the execution of the action. The action output (555) is communicated to other computing devices by a communication component (550) of the computing device (510). The communication component may include wired or wireless interfaces that operate according to open or proprietary standards. In some examples, the communication component (550) may be executed by the same hardware as the input component (515).

The action output (555) may include variety of actions, including interaction between the computing device and a variety of external networks and devices. The action output will typically be communicated to these external devices and networks via the I/O interface (515). For example, the computing device may interact with home automation systems that control lighting, entertainment, heating and security elements of the user environment. The computing device may also interact with phone systems, external computing devices, and humans to accomplish the desired action.

Although the functionality of the system for inferring and acting on user intent is illustrated within a single system, the functionality can be distributed over multiple systems, networks and computing devices. Further, the division and description of the various modules in the system are only examples. The functionality could be described in a number of alternative ways. For example, the functionality of the various modules could be combined, split, or reordered. Further, there may be a number of functions of the computing device that are not shown in FIG. 5 but are nonetheless present.

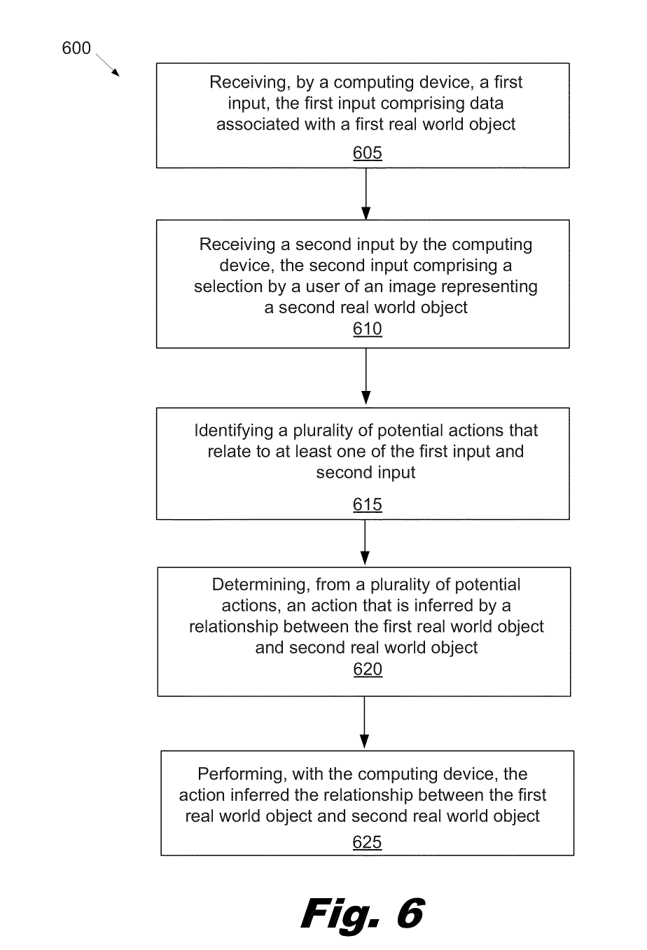

FIG. 6 is a flowchart of a generalized method for inferring and acting on user intent with a computing device. The method includes receiving a first input by a computing device, the first input comprising data associated with a first real world object (block 605). The first input may be at least one of data, voice, time, location, or sensor input associated with the first real world object. In some instances, data associated with a first real world object may include an image of the first real world object.

A second input is also received by the computing device. The second input includes a selection by a user of the computing device of an image representing a second real world object (block 610). For example, the second input may be a picture taken by the user with the computing device of the second real world object. In other examples, the user may select an image from a database or other pre-existing source of images.

A plurality of potential actions that relate to at least one of the first input and second input is identified (block 615). Identifying a plurality of potential actions that relate to at least one of the first input and second input may include a variety of procedures, including identifying actions that can be applied to the first real world object and actions that can be taken by the second real world object. In one of the examples given above, the image of the graph is the first input. A variety of potential actions may be applied to the graph including sending the graph to a different user, adjusting the way data is presented on the graph, printing the graph, saving the graph, deleting the graph, and other actions. The second input in this example is the image of the printer. A variety of actions may be applied to the printer including turning the printer on/off, printing a document on the printer, calibrating the printer, connecting to the printer, and other actions.

From the plurality of potential actions, an action is inferred by a relationship between the first real world object and second real world object (block 620). Inferring an action may include a variety of approaches including determining which of the potential actions taken by the second real world object can be applied to the first real world object. The action inferred by the relationship between the first real world object and second real world object is performed (625). In the example above, the potential action taken by the printer that relates to a document is printing a document by the printer. Thus, printing a document on the printer is the action inferred by the relationship between the document and printer.

In the example of the image of a landmark and the image of the jet (FIG. 3), a variety of actions could be associated with the landmark. The landmark could be visited, a history of the landmark could be retrieved, an event taking place at the landmark could be identified, a map of how to get to the landmark could be retrieved, and a variety of other actions. A variety of actions could be associated with the jet including obtaining information about the arrival/departure of a flight, getting tickets for the flight, retrieving rewards information for an airline, obtaining a stock quote for an airline, and a variety of other actions. The action inferred by the relationship between the landmark and the jet is obtaining a ticket for a flight to the landmark.

In other examples described above the data associated with first real world object are: sensor measurement of vitals of a user, a measurement of temperature of the user's environment, an image of pizza, voice data identifying a television channel, time data, and ambient light levels. The second real world objects are, respectively, an ambulance, an air conditioner, a house, a television, a clock and a light. The actions taken are, respectively, printing the graph on the printer, calling an ambulance or a doctor depending on the data, adjusting the settings of the air conditioner, delivering pizza to the house, changing the channel on the television, adjusting the time on the clock, and turning on/off the lamp. These are only examples. A wide variety of real world objects and actions could be involved. After the inputs are received by the computing device, the user may or may not be involved in selecting or approving the inferred action. For some more complex actions that involve more uncertainty or coordination between users, the user may be more involved in the process of selecting and execution of action. In the example shown in FIG. 3 coordination between the man and woman could be positive and important. However, in the example given in FIG. 5, the user involvement may be significantly less important. In some implementations, identifying a plurality of potential actions, determining an action that is inferred by a relationship, performing the action inferred by the relationship may be executed without user involvement whatsoever. This may be particularly attractive if the user has previous performed and approved of a particular action.

In some implementations, a database may be created that lists real world objects and potential actions associated with the real world objects. This database could be stored locally or remotely. For example, in some situations, the computing device may identify the inputs and send the inputs to the remote computer connected with the database (“remote service”) for analysis. The remote service may track a variety of requests for analysis and the actions that were actually taken in response to the analysis over time. The remote service may then rank likelihood of various actions being performed for a given input or combination of inputs. The remote service could improve its ability to predict the desired action using the accumulated data and adjust the actions based on real time trends within the data. For example, during a winter storm, the remote service may receive multiple requests that include data and objects related to cancelled airline flights from users in a specific location. Thus when a user supplies inputs that are relevant to flight delays from that location, the remote service can more accurately predict the desired action. Further, the remote service can observe which actions obtained the desired results and provide the verified actions to other users.

The principles may be implemented as a system, method or computer program product. In one example, the principles are implemented as a computer readable storage medium having computer readable program code embodied therewith. A non-exhaustive list of examples of a computer readable storage medium may include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

The computer readable program code may include computer readable program code to receive a first input by a computing device, the first input comprising data associated with a first real world object and computer readable program code to receive a second input by the computing device, the second input comprising a selection by a user of an image representing a second real world object. The computer readable program code identifies a plurality of potential actions that relate to at least one of the first input and the second input and determines, from the plurality of potential actions, an action that is inferred by a relationship between the first real world object and the second real world object. The computer readable program code performs, with the computing device, the action inferred by the relationship between the first real world object and the second real world object.

The principles described above provide a simpler, more intuitive ways to perform actions with computing device. This may reduce the impact of language barriers and provide better access to computing device functionality for those with less understanding of the steps a computing device uses to complete a task. Further, performing tasks using a computing device may be significantly simplified for the user.

The preceding description has been presented only to illustrate and describe examples of the principles described. This description is not intended to be exhaustive or to limit these principles to any precise form disclosed. Many modifications and variations are possible in light of the above teaching.

What is claimed is:

1. A method for inferring and acting on user intent comprising:
receiving a first input by a computing device, the first input comprising data associated with a first real world object;
receiving a second input by the computing device, the second input comprising a selection by a user of an image representing a second real world object;
identifying a plurality of potential actions that relate to at least one of the first input and the second input;
determining, from the plurality of potential actions, an action that is inferred by a relationship between the first real world object and the second real world object; and
performing, with the computing device, the action inferred by the relationship between the first real world object and the second real world object.

2. The method of claim 1, in which the first input is at least one of data, voice, time, location, or sensor input associated with the first real world object.

3. The method of claim 1, in which data associated with the first real world object comprises an image of the first real world object.

4. The method of claim 1, in which the second input is a picture of the second real world object taken by the user with the computing device.

5. The method of claim 1, in which the selection by the user of the image representing the second real world object comprises selection of the image from a data base.

6. The method of claim 1, in which identifying the plurality of potential actions that relate to at least one of the first input and the second input comprises identifying actions that can be applied to the first real world object and actions that can be taken by the second real world object.

7. The method of claim 1, in which determining, from the plurality of potential actions, an action that is inferred by the relationship between the first real world object and the second real world object comprises determining which of the potential actions taken by the second real world object can be applied to the first real world object.

8. The method of claim 1, in which:
the first real world object is a document;
the second input comprises a picture of a printer taken by the user with the computing device;
the action that is inferred by a relationship between the document and the printer is the printing of the document by the printer; and
performing the action inferred by the relationship comprises printing the document on the printer.

9. The method of claim 8, in which taking the picture of the printer comprises taking a picture of a barcode affixed to the exterior of the printer.

10. The method of claim 1, further comprising analyzing the image to identify the second real world object in the image.

11. The method of claim 1, in which the computing device is a remote server configured to receive the first input, receive the second input from a mobile device, identify a plurality of potential actions, determine an action that is inferred and perform the action.

12. The method of claim 1, in which the computing device electronically connects to the second real world object and communicates with the second real world object to perform the action based on the relationship between the first input and the real world object.

13. The method of claim 1, in which identifying the plurality of potential actions, determining an action that is inferred by a relationship, and performing the action inferred by the relationship is executed without user involvement.

14. The method of claim 1, in which performing the action comprises the computing device sending control data to the second real world object to influence the state of the second real world object.

15. The method of claim 1, in which the first real world object is operated on by the second real world object.

16. The method of claim 1, further comprising prompting the user for confirmation of the action prior to performing the action.

17. The method of claim 1, in which an image of the first real world object and the image of the second real world object are displayed together on a screen of the computing device, the method further comprising the user gesturing from the image of the first real world object to the image of the second real world object to define a relationship between the first real world object and second real world object.

18. A computing device for inferring and acting on user intent comprises:
an input component to receive a first input and a second input, wherein the first input comprises data associated with a first real world object and the second input comprises a selection by a user of an image representing a second real world object;
an input identification module to identify the first input and the second input;
an inference module to identify a plurality of potential actions that relate to at least one of the first input and the second input and for determining from a plurality of potential actions, an action that is inferred by a relationship between the first real world object and the second real world object;
an action module to perform the action inferred by the relationship between the first real world object and the second real world object; and
a communication component to communicate the action to a second computing device.

19. The device of claim 18, in which:
the first input comprises an image of a document viewed by the user;
the second input comprises an image of a target printer; and
the action comprises automatically and without further user action, identifying the target printer, connecting to the target printer, and printing the document on the target printer.

20. A computer readable storage medium having computer readable program code embodied therewith, the computer readable program code comprising:
computer readable program code to receive a first input by a computing device, the first input comprising data associated with a first real world object;
computer readable program code to receive a second input by the computing device, the second input comprising a selection by a user of an image representing a second real world object;
computer readable program code to identify a plurality of potential actions that relate to at least one of the first input and the second input;
computer readable program code to determine, from the plurality of potential actions, an action that is inferred by a relationship between the first real world object and the second real world object; and
computer readable program code to perform, with the computing device, the action inferred by the relationship between the first real world object and the second real world object.
